(19) United States
(12) Patent Application Publication
(10) Pub. No.: US 2007/0279677 A1
(43) Pub. Date: Dec. 6, 2007

(54) System and method for managing document processing operations from a secondary document processing device

(75) Inventors: William S. Su, Riverside, CA (US); Mohammad A. Suleiman, Trabuco Canyon, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/447,358

(22) Filed: Jun. 6, 2006

(51) Int. Cl. G06F 3/12

(52) U.S. Cl. 358/1.15

(57) ABSTRACT

The subject application is directed to a system and method for remote management of document processing operations from a different document processing device. A first document processing device receives a request for a job listing from a second document processing device, along with the second device's capabilities. The first device then generates an XML file containing information of jobs pending on the first device. The first device then sends the XML file to the second device, which receives a user selection of a job to be released to the second device from the first device. The user selection is transmitted to the first device, which encrypts/compresses the job and sends the encrypted/compressed job to the second device. When the job does not exceed the capabilities of the second device, the second device performs the document processing operation associated with the job.

### BACKGROUND OF THE INVENTION

The subject application is directed to a system and method for managing document processing operations from a different document processing device. More particularly, the subject application is directed to a system and method which allows a user to view or release any of the user's pending document processing jobs from any device associated with the system or network. The user is not limited to only viewing or releasing jobs from the device, which the user selected for the document processing job.

Typically, when a user desires to generate an electronic document, the user transmits the electronic document to a document processing device wherein the document is placed into a job queue. Most current document processing systems require the user to select a specific document processing device at the time of job submission. One issue with such systems is that the user must have the routing information for the designated device and know where the device is physically located. Another issue is if the document processing device is malfunctioning, the user may still be able to submit jobs to the device, but the device will not process any jobs until the device is again operational. Further, the selected device may be busy processing prior jobs. The user will then have to wait for the prior jobs to be processed before the user's job is processed. In order to avoid such problems, many current document processing systems will search the network for other document processing devices that can handle the jobs and inform the user of an available device or devices. The document processing system may then either automatically route the job to an available device or require the user to re-route the job. However, the available device may be physically located far from the user or the user may not know the location of the device. As such, there is a need for a document processing system and method wherein the user may retrieve the job from any device associated with the system or network.

The subject application overcomes the above noted problems and provides a system and method for managing document processing operations from a different document processing device.

### SUMMARY OF THE INVENTION

In accordance with the subject application, there is provided a system and method for managing document processing operations from a different document processing device.

Further, in accordance with the subject application, there is provided a system and method which allows a user to view or release any of the user's pending document processing jobs from any device associated with the system or network.

Still further, in accordance with the subject application, there is provided a system and method wherein the user is not limited to only viewing or releasing jobs from the device, which the user selected for the document processing job.

Still further, in accordance with the subject application, there is provided a system for remote management of document processing operations from a different document processing device. The system includes a network, a first document processing device in data communication with the network, and a second document processing device in data communication with the network. The first document processing device includes a network interface and means adapted for receiving, from the network, at least one electronic document. The first document processing device also includes means adapted for receiving, from the network, job data representative of at least one document processing operation associated with the at least one electronic document to be performed by the first document processing device. The first document processing device further comprises means adapted for communicating status data representative of a status of a state of the at least one document processing operation to the network.

The second document processing device includes a user interface, a network interface, and means adapted for receiving the status data from the network. The second document processing device also includes means adapted for generating a display on the user interface representative of received status data and means adapted for receiving document management data from an associated user representative of at least a second document processing operation associated with the at least one electronic document. The second document processing device further comprises means adapted for communicating received document management data, via the network, to the first document processing device so as to alter the at least one document processing operation.

In one embodiment, the document management data includes data representative of a rerouting of the at least one document processing operation to an alternative document processing device via the network.

In another embodiment, the system further comprises means adapted for communicating updated status data representative of an altered document processing operation to the associated user.

In still another embodiment, the second document processing device includes means adapted for securing identification data representative of at least one of an identity of the associated user, an identity of the at least one document processing operation, and the identity of the first document processing device, and wherein the identification data is used to secure the status data from the first document processing device.

In a further embodiment, at least one of the first document processing device and the second document processing device further includes means adapted for receiving at least one of the at least one electronic document and identification data in encrypted form and decryption means adapted for decrypting at least one of the at least one electronic document and identification data.

In yet a further embodiment, the status data is in XML format.

In yet another embodiment, the user interface includes a thin client adapted for XML data interchange.

Still further, in accordance with the subject application, there is provided a method for remote management of document processing operations from a different document processing device in accordance with the system described above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for remote management of document processing operations from a different document processing device according to the subject application;

FIG. 2 is a block diagram illustrating controller hardware for use in the system for remote management of document processing operations from a different document processing device according to the subject application;

FIG. 3 is a functional block diagram illustrating the controller for use in the system for remote management of document processing operations from a different document processing device according to the subject application;

FIG. 4 is a flowchart illustrating a method for remote management of document processing operations from a different document processing device according to the subject application;

FIG. 5 is a flowchart illustrating a method for retrieving a job via remote management of document processing operations from a different document processing device according to the subject application; and

FIG. 6 is a flowchart illustrating a method for releasing a job via remote management of document processing operations from a different document processing device according to the subject application.

### DETAILED DESCRIPTION OF THE PREFERRED EMBODIMENT

The subject application is directed a system and method for managing document processing operations from a different document processing device. In particular, the subject application is directed to a system and method which allows a user to view or release any of the user's pending document processing jobs from any device associated with the system or network. More particularly, the subject application is directed to a system and method wherein the user is not limited to only viewing or releasing jobs from the device, which the user selected for the document processing job.

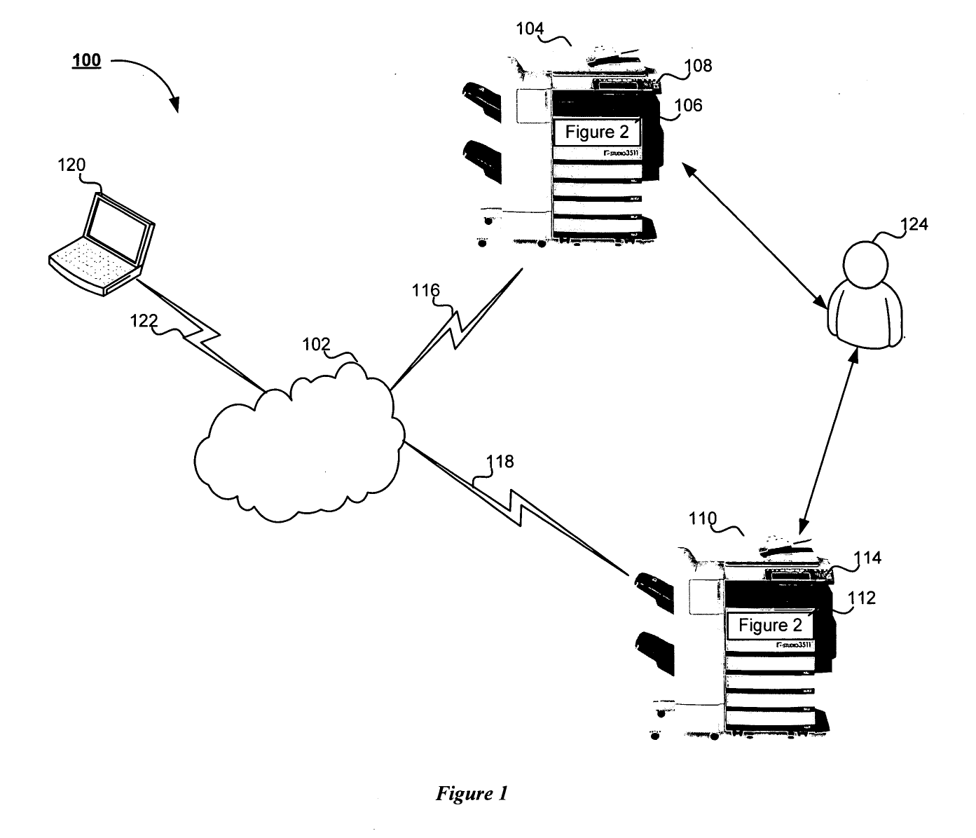

Turning now to FIG. 1, there is shown an overall diagram of the system 100 for remote management of document processing operations from a different document processing device in accordance with the subject application. As shown in FIG. 1, the system 100 employs a distributed computing environment, represented as a computer network 102. It will be appreciated by those skilled in the art that the computer network 102 is any distributed communications environment known in the art capable of enabling the exchange of data between two or more electronic devices. Those skilled in the art will further appreciate that the network 102 is any computer network known in the art including, for example and without limitation, a virtual area network, a local area network, a personal area network, the Internet, an intranet, a wide area network, or any suitable combination thereof. Preferably, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms.

The system 100 depicted in FIG. 1 further includes a first document processing device 104 and a second document processing device 110, represented as multifunction peripheral devices, suitably adapted to perform a variety of document processing operations. The skilled artisan will understand that such document processing operations include, for example and without limitation, copying, scanning, electronic mail, document management, facsimile, printing, and the like. Suitable commercially available document processing devices include, but are not limited to, the Toshiba e-Studio Series Controller. In one embodiment, the document processing devices 104 and 110 are suitably equipped to receive a plurality of portable storage media, including without limitation, Firewire drive, USB drive, SD, MMC, XD, Compact Flash, Memory Stick, and the like. In the preferred embodiment of the subject application, the document processing device 104 further includes an associated user-interface 108, such as a touch-screen interface, an alpha-numeric interface, an LCD display, or the like, via which an associated user 124 is able to interact directly with the document processing device 104. Preferably, the user-interface 114 is a thin client suitably adapted to display status information received in an XML format. Similarly, the document processing device 110 employs an associated user-interface 114, such as, for example and with limitation, an LCD display, a touch-screen interface, an alpha-numeric interface, or the like. Using the interface 114, the associated user 124 is capable of interacting directly with the document processing device 110. According to one embodiment of the subject application, the user-interface 114 of the second document processing device 110 is preferably implemented as a thin client suitably adapted to display status information received in an XML format.

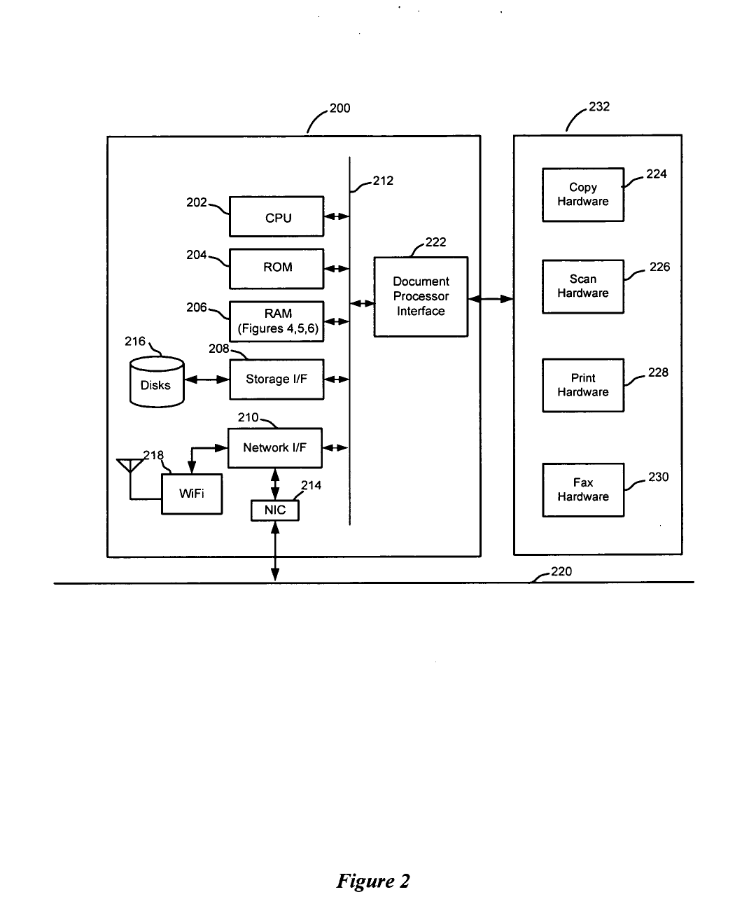

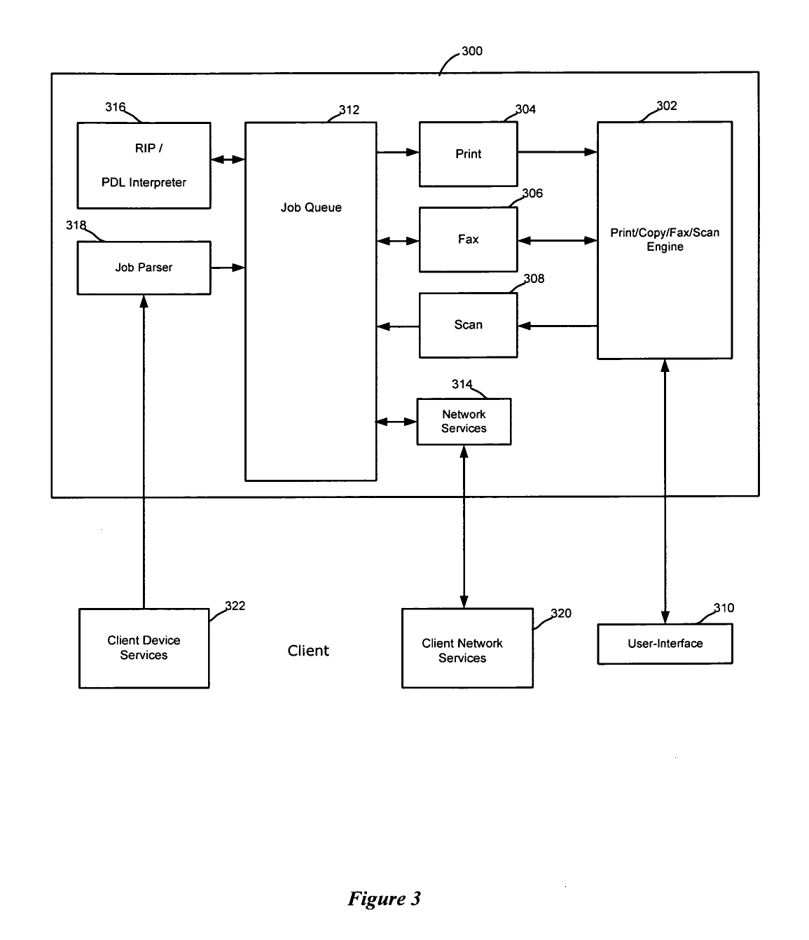

In accordance with the subject application, the first document processing device 104 further incorporates a controller 106, suitably adapted to facilitate the operations of the first document processing device 104, as will be understood by those skilled in the art. Similarly, the second document processing device 110 also employs a controller 112, suitably adapted to facilitate the operations of the second document processing device 110. Preferably, the controller 106 and controller 112 are embodied as hardware, software, or any suitable combination thereof, configured to control the operations of the associated document processing devices 104, 110, control the display of images via the associated user-interfaces 108, 114, analyze received user data, facilitate communications with external devices, and the like. While the controllers 106 and 112 are depicted in FIG. 1 as being an integrated component of the respective document processing device 104 and 110, the skilled artisan will appreciate that the controller 106 and controller 110 are suitably capable of being implemented as external devices, communicatively coupled to each respective document processing device 104 and 110. The functioning of the controller 106 and controller 110 will better be understood in conjunction with the block diagrams illustrated in FIGS. 2 and 3, explained in greater detail below.

Preferably, the document processing devices 104 and 110 are communicatively coupled to the computer network via suitable communications links 116 and 118, respectively. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. It will be understood by those skilled in the art that while only two document processing devices 104 and 110 are illustrated herein, the subject application is equally applicable to a plurality of networked document processing devices. Thus, as will be understood by those skilled in the art, the methodologies described hereinafter are capable of being employed using any number of document processing devices communicatively coupled to the computer network 102.

The system 100 further includes at least one user device 120, communicatively coupled to the computer network 102 via a communications link 122. It will be appreciated by those skilled in the art that the user device 120 is depicted in FIG. 1 as a laptop computer for illustration purposes only. As the skilled artisan will understand, the user device 120 shown in FIG. 1 is representative of any personal computing device known in the art, including, for example and without limitation, a computer workstation, a personal computer, a personal data assistant, a web-enabled cellular telephone, a smart phone, or other web-enabled electronic device. The communications link 122 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 120 is suitably adapted to generate and transmit electronic documents, as well as document processing instructions, to the document processing device 104, the document processing device 110, or any other similar device coupled to the computer network 102.

Turning now to FIG. 2, illustrated is a representative architecture of a suitable controller 200, representative of the controller 106 associated with the first document processing device 104 and the controller 112 associated with the second document processing device 110, on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system is accomplished on a suitable document processing device that includes the controller 200 of FIG. 2 as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with printer function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

Job queue 312 is also advantageously placed in data communication with an image processor 316. Image processor 316 is suitably a raster image process, page description language interpreter or any suitable mechanism for interchange of an electronic document to a format better suited for interchange with device services such as printing 304, facsimile 306 or scanning 308.

Finally, job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. Parser 318 functions to interpret a received electronic document file and relay it to a job queue 312 for handling in connection with the afore-described functionality and components.

In operation, the user device 120 advantageously submits a document processing request, inclusive of at least one electronic document and at least one associated document processing operation. It will be understood by those skilled in the art that the document processing request, or document processing job, is suitably transmitted to any one of the document processing devices 104, 110, via the computer network 102. Preferably, the user device 120 directs the document processing job to a selected document processing device, e.g., the first document processing device 104. It will be appreciated by those skilled in the art that while the user device 120 is used herein for example purposes only, the subject application is not limited solely to document processing requests from remote devices, i.e., user device 120. The skilled artisan will understand that a document processing job is capable of being initiated by the user 124 directly at the first document processing device 104, via the associated user-interface 108. It will further be understood by those skilled in the art that the electronic document received by the first document processing device 104 is capable of being received in an encrypted and/or compressed format from the user device 120 in accordance with security protocols implemented on the computer network 102.

Once the first document processing device 104 has received the electronic document, preferably included within the document processing job, the controller 106 associated with the first document processing device 104 assigns a unique job identifier to the job, so as to distinguish this job from other jobs received. In accordance with the subject application, the user 124 is able to remotely manage the operation of the first document processing device 104 with respect to the submitted document processing job, via the user-interface 114 associated with the second document processing device 110. For example, using a thin client implementation as the user-interface, the associated user 124 is able to remotely manage and view status data via the second document processing device 110. The controller 112 associated with the second document processing device 110 then receives identification data which is used to secure the status of the pending document processing job from the first document processing device 104. The skilled artisan will understand that the identification data is capable of including, for example and without limitation, the identity of the user 124, the identity of the first document processing device, the identity (job ID) of the pending document processing job, or the like. Preferably, the user 124 inputs this identification data using the user-interface 114.

The controller 112 associated with the second document processing device 110 then generates a job listing request, corresponding to the identification data, including the capabilities of the second document processing device 110. This request is then transmitted, from the second document processing device 110, to the first document processing device 104 via the computer network 102. As will be understood by those skilled in the art, suitable means of communicating between the two document processing devices 104 and 110 include, for example and without limitation, WINDOWS messaging, TCP socket, DCOM, and the like. Irrespective of the manner in which the controller 112 associated with the second document processing device 110 communicates the request to the first document processing device 104, the controller 106 associated with the first document processing device 104 receives the job listing request and determines whether or not to follow the capabilities of the second document processing device 110. That is, the controller 106 must first determine whether or not to limit the response to the request only to those pending document processing jobs matching the identification data and capable of being processed by the second document processing device 110. For example, when one or more of the jobs require 24-bit color and the second document processing device 110 is solely monochromatic, the capabilities of the second document processing device 110 are exceeded by the one or more jobs. Thereafter, the controller 106 associated with the first document processing device 104 determines whether to skip the job or add the job to the listing to be returned to the second document processing device 110. It will be appreciated by those skilled in the art that the determination is suitably based upon settings established by network protocols, administrators, or the like.

For each job that matches the identification data, for example, those jobs associated with the user 124, all jobs pending on the first document processing device 104, a particular pending job, or the like, the controller 106 associated with the first document processing device 104 determines whether to include the job or remove the job from the listing to be returned to the requesting second document processing device 110. Once the controller 106 associated with the first document processing device 104 has gathered all jobs associated with the job listing request, the jobs are compiled into a job listing XML file, which is then transmitted to the second document processing device 110. It will be understood by those skilled in the art that the use of an XML format for the job listing is for example purposes only, and other formats are equally capable of being employed in accordance with the subject application. The second document processing device 110 receives the XML document and controller 112 analyzes the job listing to determine whether any of the jobs listed exceed the second document processing device's 110 capabilities. When no jobs exceed the capabilities of the second document processing device 110, all jobs listed in the XML document are displayed to the user 124 via the thin client implementation of the user-interface 114 of the second document processing device 110.

When one or more jobs contained in the XML document exceed the capabilities of the second document processing device 110, a determination must be made by the controller 112 whether to not list those jobs or to list those jobs with warnings to the user 124 that the second document processing device 110 is unable to perform the associated document processing operations. When warnings are to be used, all jobs contained in the XML document are displayed to the user 124 via the thin client implementation of the user-interface 114, albeit with those incompatible jobs designated with warnings to the user 124. When it is determined by the controller 112 associated with the second document processing device 110 that the incompatible jobs are not to be displayed, the second document processing device 110 displays all jobs compatible with its processing capabilities, while hiding those incompatible jobs from the user 124 on the associated user-interface 114.

The user 124, at the second document processing device 110, then selects one or more of the jobs displayed on the associated the thin client implementation of the user-interface 114 to be released to the second document processing device 110 from the first document processing device 104 for output thereon. As the XML file contains the unique job ID for each of the jobs contained in the document, the controller 112 associated with the second document processing device 110 is able to compile a listing of job ID's associated with the selections made by the user 124. This listing is then encrypted and/or compressed and transmitted to the first document processing device 104 via any suitable means known in the art. It will be appreciated by those skilled in the art that any suitable methods for encrypting and/or compressing electronic documents known in the art are capable of being implemented in accordance with the subject application. Preferably, the encrypted/compressed listing is transmitted via a secure communications channel, as will be appreciated by those skilled in the art.

Upon receipt of the encrypted/compressed listing, the controller 106 associated with the first document processing device 104 decrypts and/or decompresses the listing to retrieve the job ID's associated with the selections made by the user 124. Those jobs designated by the job ID's are then retrieved from the queue or queues in which they currently reside and are thereafter encrypted and/or compressed by the first document processing device 104. It will be appreciated by those skilled in the art that any suitable method for encrypting and compressing electronic documents known in the art are capable of being implemented in accordance with the subject application. The encrypted/compressed job or jobs are then transmitted, via the computer network 102, from the first document processing device 104 to the second document processing device 110. The controller 112 associated with the second document processing device 110 then decompresses/decrypts the received job or jobs and adds that job or jobs to the corresponding output queue. For example, when one or more of the jobs were stored in a print immediately queue on the first document processing device 104, and one or more other jobs were stored in a private print queue on the first document processing device 104, each job will be added to the same type of queue on the second document processing device 110.

Thereafter, a job is retrieved from its queue by the controller 112 associated with the second document processing device 110 and a determination is made as to whether the job exceeds the capabilities of the second document processing device 110. When the retrieved job exceeds the capabilities, the retrieved job is skipped and the user 124 is notified of the incompatible job. When the job does not exceed the capabilities of the second document processing device 110, a determination must be made as to whether the job is in a format different from that which the second document processing device 110 uses. When the format is compatible, the job is output in accordance with the designated document processing operation. When the format is not compatible with the format recognized by the second document processing device 110, the job is converted, by the controller 112, to an acceptable format and the job is output thereafter.

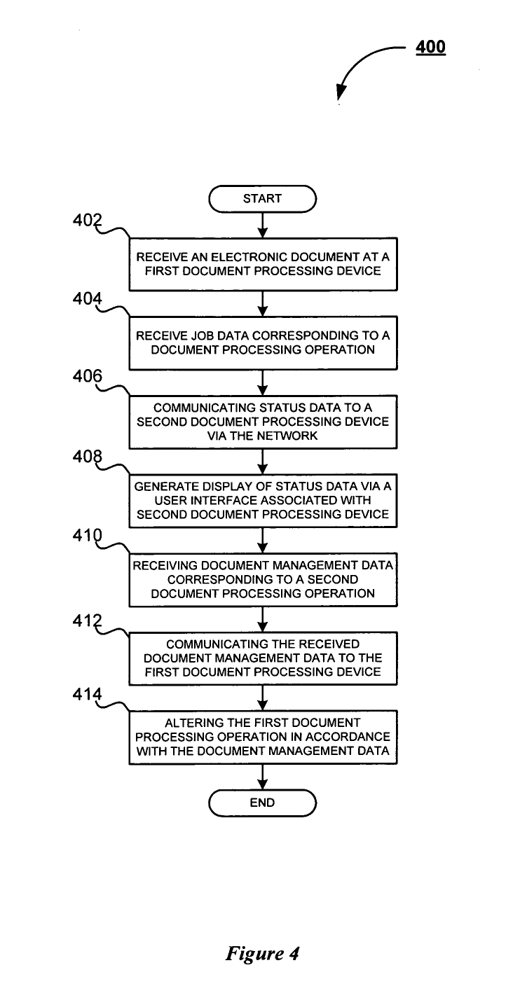

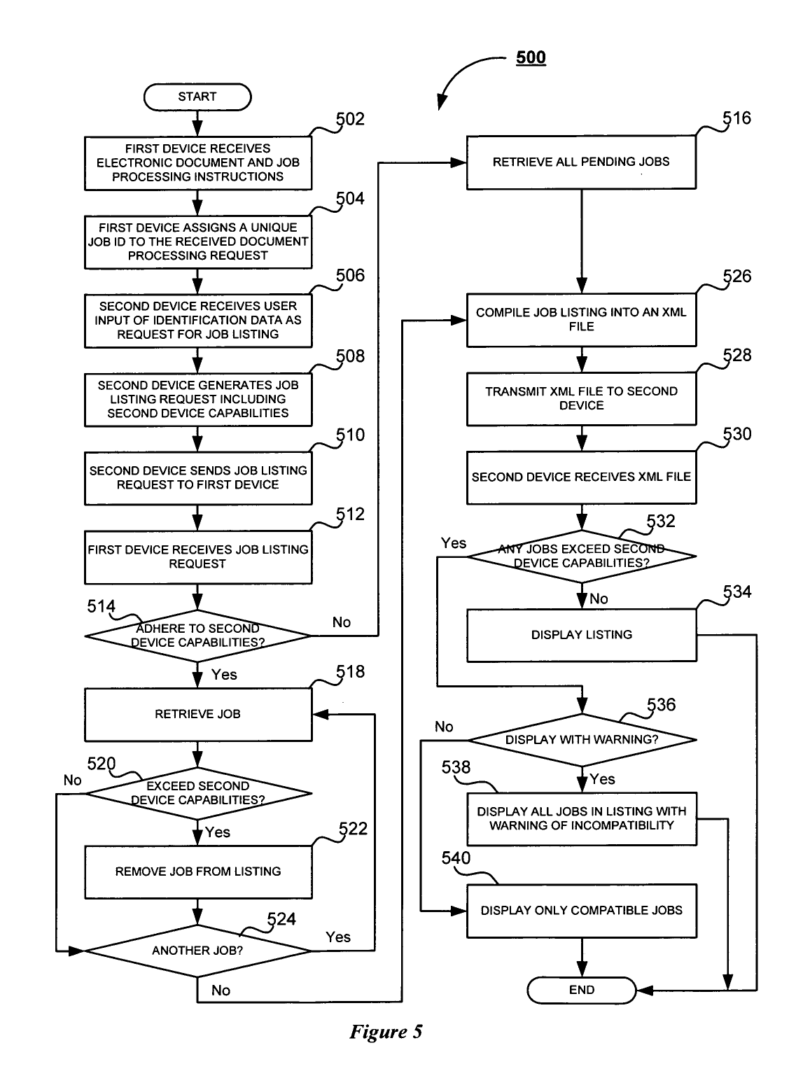

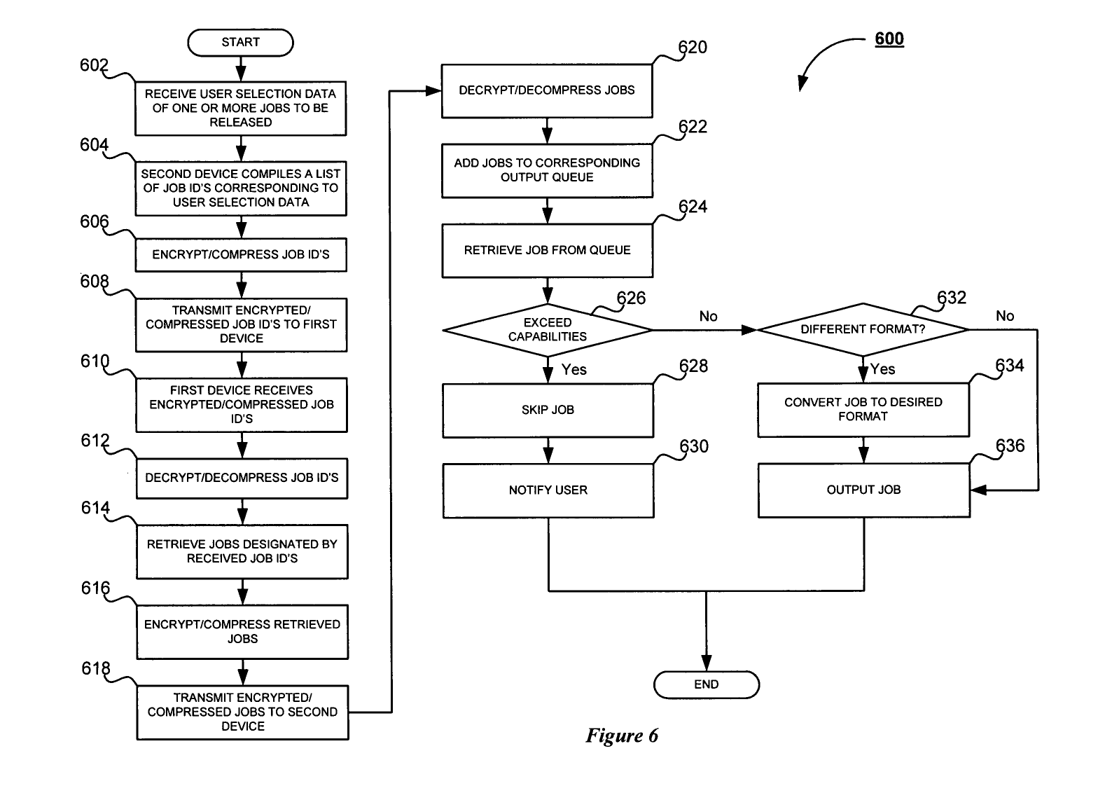

The foregoing system 100 and components shown in FIG. 1, FIG. 2, and FIG. 3 will better be understood when viewed in conjunction with the methodologies embodied by the flowcharts described in FIG. 4, FIG. 5, and FIG. 6, below.

Turning now to FIG. 4, there is shown a flowchart 400 illustrating a method for remote management of document processing operations from a different document processing device in accordance with the subject application. Beginning at step 402, the first document processing device 104 receives an electronic document. It will be understood by those skilled in the art that the electronic document is capable of being received from the user device 120, a network storage, a portable storage medium, an electronic mail message attachment, or any other means known in the art. The controller 106 associated with the first document processing device 104 then receives, at step 404, job data corresponding to at least one selected document processing operation associated with the received electronic document. In accordance with one embodiment of the subject application, the first document processing device 104 is capable of receiving the electronic document and/or the job data in an encrypted and/or compressed format from the user device 120, an electronic mail message, a network storage, a portable storage medium, or other means known in the art. In such an embodiment, the controller 106 associated with the first document processing device 104 would further decrypt and/or decompress the received electronic document and/or job data for further operations in accordance with the subject application.

Status data representing the state of the document processing operation is then communicated, via the computer network 102, from the controller 106 associated with the first document processing device 104 to the controller 112 associated with the second document processing device 110 at step 406. The second document processing device 110 then generates, at step 408, a display of the status data via the user-interface 114 to the user 124. In accordance with the subject application, a thin client is implemented as the user-interface 114 suitably adapted to display status data received in an XML format. The controller 112 associated with the second document processing device 110 then receives at step 410 document management data corresponding to a second document processing operation. It will be understood by those skilled in the art that such document management data is representative of instructions received from the user 124, preferably via the user-interface 114. The second document processing device 110 then communicates the received document management data to the first document processing device 104 at step 412. Thereupon, the controller 106 associated with the first document processing device 104 alters the first document processing operation in accordance with the document management data. The methodology embodied in FIG. 4 will better be understood when viewed in conjunction with the methodology described in FIGS. 5 and 6.

Referring now to FIG. 5, there is shown a flowchart 500 illustrating a method for retrieving a job via remote management of document processing operations from a different document processing device in accordance with the subject application. At step 502, the first document processing device 104 receives electronic document data and job processing instructions. Preferably, the job processing instructions correspond to at least one document processing operation. As the skilled artisan will appreciate, the electronic document data is capable of being received from the user device 120, a portable storage device, a network storage device, an attachment to an electronic mail message, or the like. The job processing instructions, corresponding to the at least one document processing operation, are capable of being input during the transmittal of the electronic document from the user device 120 to the first document processing device 104, upon insertion and selection of the portable storage medium, upon retrieval from the network storage device, in the electronic mail message, or the like. Irrespective of the manner in which the first document processing device 104 receives the electronic document and the job processing instructions, the first document processing device 104 assigns a unique job ID to the received document processing request at step 504. In accordance with one embodiment of the subject application, the first document processing device 104 is capable of receiving the electronic document and/or the job data in an encrypted and/or compressed format. In such an embodiment, the controller 106 associated with the first document processing device 104 would further decrypt and/or decompress the received electronic document and/or job data for further operations in accordance with the subject application.

At step 506, the second document processing device 110 receives the user 124 input of identification data as a request for a listing of pending document processing jobs. Preferably, the identification data includes, for example and without limitation, identification information associated with the user 124, identification information associated with the first document processing device 104, identification information associated with a selected document processing operation, identification information associated with a particular document processing job, or the like. In accordance with the subject application, the request initiated by the user 124 is received by the second document processing device 110 via the associated user-interface 114. A job listing request is then generated by the controller 112 associated with the second document processing device 110 inclusive of the identification information provided by the user 124 and the document processing capabilities of the second document processing device 110 at step 508.

The job listing request is transmitted to the first document processing device 104 from the second document processing device 110 via the computer network 102 at step 510. The controller 106 associated with the first document processing device 104 then receives the job listing request at step 512 and determines at step 514 whether to adhere to the capabilities of the second document processing device 110 when responding. That is, the controller 106 first determines whether jobs that exceed the processing capabilities of the second document processing device 110 should be included in any response to the request for job listings. It will be understood by those skilled in the art that the determination is capable of being selected by a network administrator during installation of each document processing device 104, 110, based upon device settings, or the like. When it is determined by the controller 106 at step 514 that the first document processing device 104 is not to adhere to the limitations of the second document processing device 110, flow proceeds to step 516, whereupon all pending jobs that match the identification data are retrieved from their respective queues and at step 526 to compile a job listing in an XML file.

When it is determined at step 514 that the capabilities of the second document processing device 110 are to be taken into consideration when responding to the job listing request, the controller 106 associated with the first document processing device 104 retrieves the first document processing job, matching the identification data, from its respective queue at step 518. A determination is then made at step 520 whether processing the retrieved job is beyond the ability of the second document processing device 110. For example, when the retrieved job requires 24-bit color output and the second document processing device 110 is monochromatic only, the job is determined to exceed the processing capabilities of the second document processing device 110. Upon such a determination, flow proceeds to step 522, whereupon the job is removed from the listing and flow proceeds to step 524 for a determination whether another job remains matching the identification data. When an additional job remains, flow returns to step 518, whereupon the next job is retrieved from its respective queue. Flow then proceeds to step 520, whereupon a determination is made whether the retrieved job exceeds the capabilities of the second document processing device 110. When the job is compatible with the processing abilities of the second document processing device 110, flow proceeds directly to step 524 for a determination whether any jobs meeting the identification data remain. When no additional jobs remain in the first document processing device's queues that match the identification, flow proceeds to step 526, whereupon all jobs that match the identification data and are compatible with the output processing capabilities of the second document processing device 110 are compiled into the requested job listing contained in an XML file.

It will be appreciated by those skilled in the art that the use of the XML file enables document processing devices having varied operating systems to communicate, as the XML format is capable of being understood by a variety of devices. The XML file is then transmitted by the first document processing device 104 to the second document processing device 110 via the computer network 102 at step 528. Preferably, the XML file is transmitted from the first document processing device 104 to the second document processing device 110 using window messages, TCP socket, DCOM, or the like, as will be appreciated by those skilled in the art. It will be appreciated by those skilled in the art that the job listing of the XML file contains a variety of information with respect to the retrieved jobs including, for example and without limitation, the unique job ID, the job processing instructions, the associated document processing operations, and the like. The second document processing device 110 then receives the XML file at step 530 and determines at step 532 whether any of the jobs listed in the XML exceed the capabilities of the second document processing device 110. When no jobs exceed the processing capabilities or output capabilities of the second document processing device 110, flow proceeds to step 534, whereupon the complete listing of the jobs is displayed to the user 124 via the thin client implementation of the associated user-interface 114.

When one or more jobs contained in the job listing of the XML file exceed the capabilities of the second document processing device 110, flow proceeds from step 532 to step 536, whereupon a determination is made whether to display the non-compatible jobs with a warning to the user 124. It will be understood by those skilled in the art that such a setting for the second document processing device 110, i.e., warning the user 124 of incompatible jobs, is capable of being set by a system administrator, by the user 124, network protocols, or the like. When warnings are to be used, flow proceeds to step 538, whereupon all the jobs listed in the XML file are displayed to the user 124, albeit with the incompatible jobs designated by a warning to the user 124 that processing by the second document processing device 110 is not available. When no warnings are to be used, flow proceeds from step 536 to step 540, whereupon all compatible jobs are displayed to the user 124 via the thin client implementation of the associated user-interface 114, with those incompatible jobs hidden from the user 124.

The methodology for retrieving job information, as set forth above in FIG. 5, will be better understood when viewed in conjunction with the methodology for releasing one or more of the identified jobs illustrated in FIG. 6. Turning now to FIG. 6, there is shown a flowchart 600 illustrating a method for releasing a job via remote management of document processing operations from a different document processing device in accordance with the subject application. At step 602, the second document processing device 110 receives selection data from the associated user 124 of one or more jobs, identified in the XML file, to be released to the second document processing device 110. The second document processing device 110 then compiles a listing of job IDs corresponding to the user 124 selection data at step 604 and encrypts/compresses this listing at step 606. The skilled artisan will appreciate that the subject application is capable of employing any method of encryption and/or compression known in the art. The encrypted/compressed listing of job IDs is then transmitted to the first document processing device 104 over the computer network 102 at step 608.

The first document processing device 104 receives the compressed/encrypted listing of job IDs at step 410 and performs a suitable decompression/decryption operation thereon at step 612. Those jobs designated by the job IDs are then retrieved from their respective queues at step 614 by the first document processing device 104. The retrieved jobs are then encrypted and/or compressed by the first document processing device 104 at step 616, whereupon the compressed/encrypted jobs are transmitted to the second document processing device 110 at step 618. Preferably, the transmission of the encrypted/compressed jobs is accomplished using a suitable secure communications channel, as will be appreciated by those skilled in the art.

The second document processing device 110 then receives the jobs and decrypts/decompresses the jobs at step 620. The jobs are then added to the corresponding output queues on the second document processing device 110 at step 622. In order to complete the release of the transferred jobs, a job is retrieved, at step 624, from its corresponding queue, e.g., private, immediate, etc. A determination is then made at step 426 whether the retrieved job exceeds the capabilities of the second document processing device 110. When the second device 110 is unable to completed the retrieved job, the job is skipped at step 628 and flow proceeds to step 630, whereupon the user is notified of the problem. When the job does meet the capabilities of the second document processing device 110, flow proceeds to step 632, whereupon a determination is made whether the job is in a format different from that of the second document processing device 110. That is, the second document processing device 110 must first determine whether the job has to be converted to a format different from the format in which it was stored on the first document processing device 104. When the job must first be converted, flow proceeds from step 632 to step 634, whereupon the job is converted to the required format. The job is then output in accordance with the document processing operation associated with the job at step 636. When no conversion is required, i.e., the job is in an acceptable or compatible format, flow proceeds directly to step 636 for output by the second document processing device 110.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for remote management of document processing operations from a different document processing device comprising:
a network;
a first document processing device in data communication with the network, including,
a network interface;
means adapted for receiving, from the network, at least one electronic document;
means adapted for receiving, from the network, job data representative of at least one document processing operation associated with the at least one electronic document to be performed by the first document processing device; and
means adapted for communicating status data representative of a status of a state of the at least one document processing operation to the network;
a second document processing device, in data communication with the network, including,
a user interface;
a network interface;
means adapted for receiving the status data from the network;
means adapted for generating a display on the user interface representative of received status data;
means adapted for receiving document management data from an associated user representative of at least a second document processing operation associated with the at least one electronic document; and
means adapted for communicating received document management data, via the network, to the first document processing device so as to alter the at least one document processing operation.

2. The system for remote management of document processing operations of claim 1 wherein the document management data includes data representative of a rerouting of the at least one document processing operation to an alternative document processing device via the network.

3. The system for remote management of document processing operations of claim 1 further comprising means adapted for communicating updated status data representative of an altered document processing operation to the associated user.

4. The system for remote management of document processing operations of claim 1 wherein the second document processing device includes means adapted for securing identification data representative of at least one of an identity of the associated user, an identity of the at least one document processing operation, and an identity of the first document processing device, and wherein the identification data is used to secure the status data from the first document processing device.

5. The system for remote management of document processing operations of claim 4 wherein at least one of the first document processing device and the second document processing device includes:
means adapted for receiving at least one of the at least one electronic document and the identification data in encrypted form; and
decryption means adapted for decrypting at least one of the at least one electronic document and identification data.

6. The system for remote management of document processing operations of claim 4 wherein the status data is in XML format.

7. The system for remote management of document processing operations of claim 1 wherein the user interface includes a thin client adapted for XML data interchange.

8. A method for remote management of document processing operations from a different document processing device comprising the steps of:
receiving at least one electronic document at a first document processing device via an associated network;
receiving, at the first document processing device via the network, job data representative of at least one document processing operation associated with the at least one electronic document to be performed by the first document processing device;
communicating status data representative of a status of a state of the at least one document processing operation from the first document processing device to the network;
receiving the status data at a second document processing device in data communication with the network,
generating a display representative of received status data on a user interface associated with the second document processing device;
receiving document management data representative of at least a second document processing operation associated with the at least one electronic document from an associated user at the second document processing device; and
communicating received document management data from the second document processing device, via the network, to the first document processing device so as to alter the at least-one document processing operation.

9. The method for remote management of document processing operations of claim 8 wherein the document management data includes data representative of a rerouting of the at least one document processing operation to an alternative document processing device via the network.

10. The method for remote management of document processing operations of claim 8 further comprising the step of communicating updated status data representative of an altered document processing operation to the associated user.

11. The method for remote management of document processing operations of claim 8 further comprising the step securing, via the second document processing device, identification data representative of at least one of an identity of the associated user, an identity of the at least one document processing operation, and an identity of the first document processing device, and wherein the identification data is used to secure the status data from the first document processing device.

12. The method for remote management of document processing operations of claim 11 further comprising the steps of:
receiving, via at least one of the first document processing device and the second document processing device, at least one of the at least one electronic document and identification data in encrypted form; and
decrypting at least one of the at least one electronic document and the identification data.

13. The method for remote management of document processing operations of claim 11 wherein the status data is in XML format.

14. A computer-implemented method for remote management of document processing operations from a different document processing device comprising the steps of:
receiving at least one electronic document at a first document processing device via an associated network;
receiving, at the first document processing device via the network, job data representative of at least one document processing operation associated with the at least one electronic document to be performed by the first document processing device;
communicating status data representative of a status of a state of the at least one document processing operation from the first document processing device to the network;
receiving the status data at a second document processing device in data communication with the network,
generating a display representative of received status data on a user interface associated with the second document processing device;
receiving document management data representative of at least a second document processing operation associated with the at least one electronic document from an associated user at the second document processing device; and
communicating received document management data from the second document processing device, via the network, to the first document processing device so as to alter the at least one document processing operation.

15. The computer-implemented method for remote management of document processing operations of claim 14 wherein the document management data includes data representative of a rerouting of the at least one document processing operation to an alternative document processing device via the network.

16. The computer-implemented method for remote management of document processing operations of claim 14 further comprising the step of communicating updated status data representative of an altered document processing operation to the associated user.

17. The computer-implemented method for remote management of document processing operations of claim 14 further comprising the step securing, via the second document processing device, identification data representative of at least one of an identity of the associated user, an identity of the at least one document processing operation, and an identity of the first document processing device, and wherein the identification data is used to secure the status data from the first document processing device.

18. The computer-implemented method for remote management of document processing operations of claim 17 further comprising the steps of:
receiving, via at least one of the first document processing device and the second document processing device, at least one of the at least one electronic document and identification data in encrypted form; and
decrypting at least one of the at least one electronic document and the identification data.

19. The computer-implemented method for remote management of document processing operations of claim 17 wherein the status data is in XML format.
